(19) United States
(12) Patent Application Publication
(10) Pub. No.: US 2026/0141297 A1
(43) Pub. Date: May 21, 2026

(54) REINFORCEMENT LEARNING-BASED AGENT POLICY GENERATION METHOD AND NON-TRANSITORY COMPUTER-READABLE MEDIUM

(71) Applicants: INVENTEC (PUDONG) TECHNOLOGY CORPORATION, Shanghai (CN); INVENTEC CORPORATION, Taipei City (TW)

(72) Inventors: Guilherme Henrique GALELLI CHRISTMANN, Taipei City (TW); Ying-sheng LUO, Taipei City (TW); Hanjaya MANDALA, Taipei City (TW); Wei-Chao CHEN, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 19/240,461

(22) Filed: Jun. 17, 2025

(30) Foreign Application Priority Data
Nov. 19, 2024 (CN) 202411660788.9

(51) Int. Cl. G06N 20/00

(52) U.S. Cl. CPC G06N 20/00

(57) ABSTRACT

A reinforcement learning-based agent policy generation method and a non-transitory computer-readable media are proposed. The method includes: obtaining a first state, an action network and a value network of an agent, and a reward function of an environment in which the agent is located; generating a first action for the agent to execute according to the action network and the first state, and generating a first value according to the value network and the first state; obtaining a second state of the agent generated by the environment and a reward generated by the reward function; storing the first state, the first action, the first value, the second state, and the reward into a buffer; and training the value network and the action network according to the buffer; wherein a loss function of the action network includes a policy gradient loss and a regularization loss.

### CROSS-REFERENCE TO RELATED APPLICATIONS

This non-provisional application claims priority under 35 U.S.C. § 119 (a) on Patent Application No(s). 202411660788.9 filed in China on Nov. 19, 2024, the entire contents of which are hereby incorporated by reference.

### BACKGROUND

### 1. Technical Field

The present disclosure relates to reinforcement learning, and more particular to a reinforcement learning-based agent policy generation method and non-transitory computer-readable medium.

### 2. Related Art

Reinforcement learning (RL) policies are prone to high frequency oscillations. When no limitations or constraints are imposed in either the learning or in the environment, RL agents commonly develop exploitative behavior that maximizes reward to the detriment of everything else. Chasing high task performance (reward) is the goal of learning, but there are scenarios where additional factors must be considered. For example, when deploying a policy to hardware in the real-world, high-frequency oscillations are especially undesirable as they can cause damage to the actuators and other hardware.

A straightforward way to mitigate the issue is to include penalization terms as part of the reward function. However, the learning algorithm tendency to exploit the reward function can lead to policies where subpar performance is preferred in favor of smoothness. Furthermore, reward function design is a complex matter, and can be difficult to express for many tasks in the first place. Adding additional penalization terms for high frequency oscillations essentially modifies the original learning objective, and can be difficult to tune. If the penalization weight is too large, the policy might prefer to not do much at all in order to avoid large negative rewards. On the other hand, if the weight is too small it might choose to ignore it and still generate high frequency oscillations. An ideal method should maintain the originally designed reward function and remove the need of adding new elements of complexity.

Another approach to reduce high-frequency oscillations is to filter the actions outputted from the policy, for example with a low-pass filter. In terms of the classic agent-environment diagram in RL, this type of approach can be construed as adding a constraint to the environment rather than to the agent (or policy) itself. In fact, filtering the actions can lead to even larger oscillations in the raw outputs of the policy. A major drawback of using a traditional filter, e.g. a lowpass filter, is that it has memory. This means that if the observation space does not include past actions and past observations the policy will not be able to learn an effective model, as it violates the assumption of a Markov Decision Process. Although this can be solved by keeping history buffer over multiple steps, it requires larger models in terms of parameters and complexity.

### SUMMARY

In view of the above, the present disclosure provides a reinforcement learning-based agent policy generation method and a non-transitory computer-readable medium, which mitigate the issue of high-frequency oscillations in deep reinforcement learning from the perspectives of network architecture and loss regularization, rather than relying on penalty terms in the reward function or environment modifications (such as post-processing actions).

According to one or more embodiment of the present disclosure, a reinforcement learning-based agent policy generation method comprises a plurality of steps performed by a computing device. The plurality of steps comprises: obtaining a first state, an action network and a value network of an agent, and a reward function of an environment in which the agent is located; generating a first action for the agent to execute according to the action network and the first state, and generating a first value according to the value network and the first state; obtaining a second state of the agent generated by the environment and a reward generated by the reward function; storing the first state, the first action, the first value, the second state, and the reward into a buffer; and training the value network and the action network according to the buffer; wherein a loss function of the action network includes a policy gradient loss and a regularization loss, the regularization loss comprises a first distance and a second distance, the first distance is associated with the first action, and the second distance is associated with the first action or the first value.

According to one or more embodiment of the present disclosure, a non-transitory computer-readable medium stores a plurality of instructions. The plurality of instructions is configured to be performed by a computing device and cause a plurality of operations, and the plurality of operations comprises: obtaining a first state, an action network and a value network of an agent, and a reward function of an environment in which the agent is located; generating a first action for the agent to execute according to the action network and the first state, and generating a first value according to the value network and the first state; obtaining a second state of the agent generated by the environment and a reward generated by the reward function; storing the first state, the first action, the first value, the second state, and the reward into a buffer; and training the value network and the action network according to the buffer; wherein a loss function of the action network includes a policy gradient loss and a regularization loss, the regularization loss comprises a first distance and a second distance, the first distance is associated with the first action, and the second distance is associated with the first action or the first value.

In summary, the present disclosure provides a reinforcement learning-based agent policy generation method and a non-transitory computer-readable medium. Instead of relying on explicit reward penalty terms or environment adjustments (such as post-processing actions), the present disclosure adopts loss regularization and network architecture to encourage the policy to learn a smooth mapping, such that neighboring states in the input space result in neighboring actions in the output space.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a flowchart of the reinforcement learning-based agent policy generation method according to an embodiment of the present disclosure;

FIG. 2 is a flowchart illustrating the regularization loss calculation according to a first embodiment of the present disclosure;

FIG. 3 is a flowchart illustrating the regularization loss calculation according to a second embodiment of the present disclosure;

FIG. 4 is a flowchart illustrating the operation of the feedforward layer of the action network according to an embodiment of the present disclosure; and

FIG. 5 and FIG. 6 present evaluation results of applying the present disclosure in a real-world robotic application.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

The present disclosure proposes a reinforcement learning-based agent policy generation method, which is adaptable to be performed by a computing device. In an embodiment, the computing device may adopt at least one of the following examples: a personal computer, a network server, a central processing unit (CPU), a graphics processing unit (GPU), a microcontroller (MCU), an application processor (AP), a field-programmable gate array (FPGA), an application-specific integrated circuit (ASIC), a system-on-a-chip (SoC), a deep learning accelerator, or any other electronic device with similar functionality.

The present disclosure does not limit the hardware type of the computing device. The present disclosure further proposes a non-transitory computer-readable medium storing a plurality of instructions. When the plurality of instructions is performed by the computing device, the computing device may perform a plurality of operations corresponding to the reinforcement learning-based agent policy generation method proposed in an embodiment of the present disclosure.

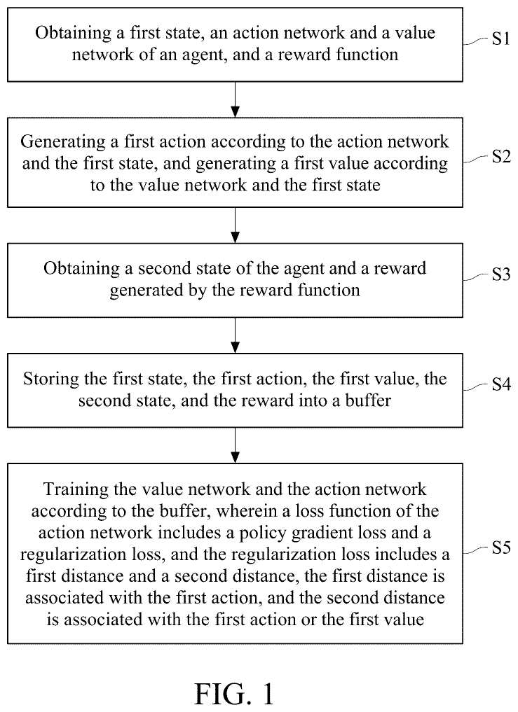

FIG. 1 is a flowchart of the reinforcement learning-based agent policy generation method according to an embodiment of the present disclosure, including steps S1 to S5. In step S1, the computing device obtains a first state, an action network and a value network of anagent, and a reward function of an environment in which the agent is located. In step S2, the computing device generates a first action for the agent to execute according to the action network and the first state, and generates a first value according to the value network and the first state. In step S3, the computing device obtains a second state of the agent generated by the environment and a reward generated by the reward function. In step S4, the computing device stores the first state, the first action, the first value, the second state, and the reward into a buffer. In step S5, the computing device trains the value network and the action network according to the buffer, wherein a loss function of the action network includes a policy gradient loss and a regularization loss, and the regularization loss includes a first distance and a second distance, the first distance is associated with the first action, and the second distance is associated with the first action or the first value.

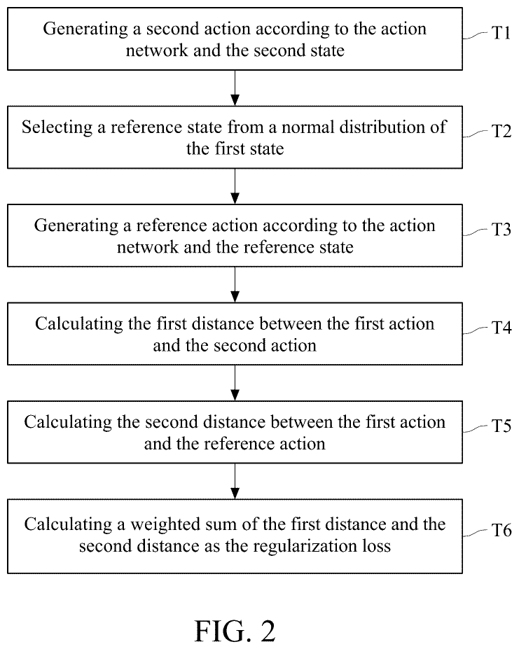

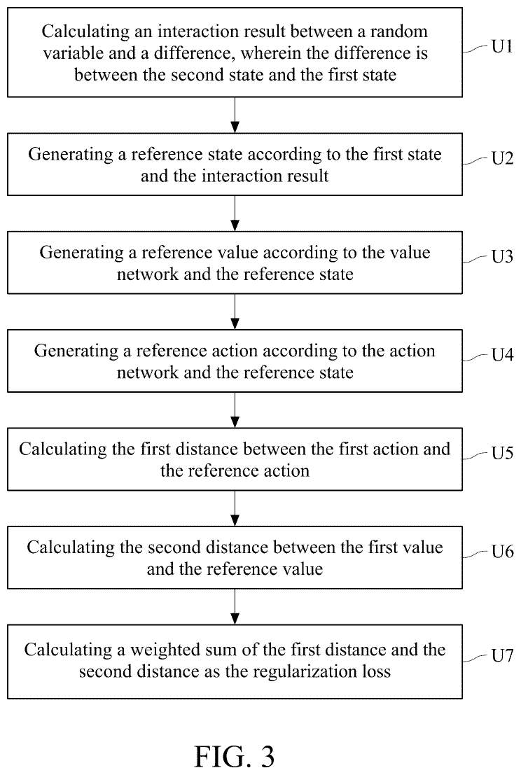

The above process applies a loss regularization method, which aims to reduce the action oscillation frequency by adding a regularization component to the standard reinforcement learning (RL) loss function, rather than directly to the reward function. Its general form is: [symbol] = [symbol] _{RL}+ [symbol] _{Reg}, where [symbol] _{RL} is a policy gradient loss, and [symbol] _{Reg} is the regularization loss. FIG. 2 and FIG. 3 illustrate two embodiments of regularization loss calculation.

FIG. 2 is a flowchart illustrating the regularization loss calculation according to a first embodiment of the present disclosure, including steps T1 to T6. In step T1, the computing device generates a second action according to the action network and the second state. In step T2, the computing device selects a reference state from a normal distribution of the first state. In step T3, the computing device generates a reference action according to the action network and the reference state. In step T4, the computing device calculates the first distance between the first action and the second action. In step T5, the computing device calculates the second distance between the first action and the reference action. In step T6, the computing device calculates a weighted sum of the first distance and the second distance as the regularization loss.

Two regularization components are used in the process illustrated in FIG. 2. The first is a temporal component [symbol] _{T}, which minimizes the distance between the actions of two consecutive states, sₜ and sₜ₊₁. The second is a spatial component [symbol] _{S}, which minimizes the difference between the state sₜ and a state s̅ₜ. The state s̅ₜ is sampled from a normal distribution in the neighborhood of sₜ, and is defined as follows:

[symbol] _{T}=D(π_{θ}(sₜ), π_{θ}(sₜ₊₁), where sₜ denotes the first state, sₜ₊₁ denotes the second state, π_{θ}(·) denotes the action network, so π_{θ}(sₜ) denotes to the first action and π_{θ}(sₜ₊₁) denotes to the second action generated in step T1; D(·) is a distance function, and [symbol] _{T} denotes the first distance calculated in step T4.

[symbol] _{S}=D(π_{θ}(sₜ), π_{θ}(s̅ₜ), where sₜ˜ [symbol] (sₜ, σ). This corresponds to steps T2, T3, and T5. Here, s̅ₜ denotes the reference state, and [symbol] (sₜ, σ) denotes a normal distribution with a mean of the reference state sₜ and standard deviation σ, where σ is a tunable hyperparameter. The spatial component [symbol] _{S} computes the second distance.

[symbol] _{CAPS}=λ_{T} [symbol] _{T}+λ_{S} [symbol] _{S}, corresponding to step T6, where λ_{T} and λ_{S} are tunable hyperparameters.

FIG. 3 is a flowchart illustrating the regularization loss calculation according to a second embodiment of the present disclosure, including steps U1 to U7. In step U1, the computing device calculates an interaction result between a random variable and a difference, wherein the difference is between the second state and the first state. In step U2, the computing device generates a reference state according to the first state and the interaction result. In step U3, the computing device generates a reference value according to the value network and the reference state. In step U4, the computing device generates a reference action according to the action network and the reference state. In step U5, the computing device calculates the first distance between the first action and the reference action. In step U6, the computing device calculates the second distance between the first value and the reference value. In step U7, the computing device calculates a weighted sum of the first distance and the second distance as the regularization loss.

The process illustrated in FIG. 3 also uses two regularization components, similar to the spatial components described in the first embodiment. Distinctively, the regularization is employed both to the outputs of the action network Ne and the value network V_{θ}. Additionally, the sampling distance is bounded relative to the difference of two consecutive states sₜ and sₜ₊₁, rather than a predefined hyperparameter of the first embodiment. The detailed calculation is as follows:

s̅ₜ=sₜ+(sₜ₊₁−sₜ)·u, where u˜U(·), s̅ₜ denotes the reference state generated in step U2, and u is a random variable drawn from a uniform distribution U(·). Thus, (sₜ₊₁−sₜ)·u is the interaction result calculated in step U1.

[symbol] _{s,π}=D(π_{θ}(sₜ), π_{θ}(s̅ₜ), where π_{θ}(sₜ) denotes the first action, π_{θ}(s̅ₜ) denotes the reference action generated in step U4, and [symbol] _{s,π} denotes the first distance calculated in step U5.

[symbol] _{s,V}=D(V_{θ}(sₜ), V_{θ}(s̅ₜ), where V_{σ}(·) denotes the value network, so V_{θ}(sₜ) denotes the first value and V_{σ}(s̅ₜ) denotes the reference value generated in step U3. [symbol] _{s,V} denotes the second distance calculated in step U6.

[symbol] _{L2C2}=λ_{π} [symbol] _{s,π}+λ_{V} [symbol] _{s,V}, corresponding to step U7, where λ_{π} and λ_{V} are the weights of the regularization components, and λ_{V}=βλ_{π}. The lower bound of λ_{π} is denoted as λ, and the upper bound as λ̅.

The second embodiment of the regularization loss calculation is similar to the first embodiment, with the primary difference being the sampling method. It can be considered that the temporal element in the first embodiment is redundant, since a state that is sampled nearby and two consecutive states should produce more or less the same regularization signal. Therefore, the second embodiment drops the temporal element in favor of optimizing both the action network and the value network outputs with a spatial regularization.

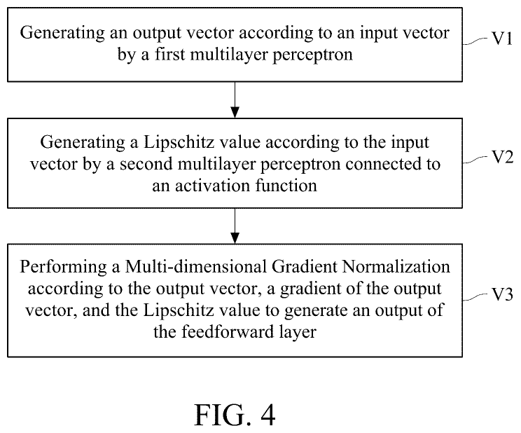

FIG. 4 is a flowchart illustrating the operation of the feedforward layer of the action network according to an embodiment of the present disclosure, including steps V1 to V3.

In step V1, the computing device generates an output vector f(x) according to an input vector x by a first multilayer perceptron. This step corresponds to the operation of a conventional feedforward layer.

In step V2, the computing device generates a Lipschitz value K(x) according to the input vector x by a second multilayer perceptron connected to an activation function. In an embodiment, the activation function may be a Softplus function or a linear function, and the present disclosure is not limited thereto.

In step V3, the computing device performs a Multi-dimensional Gradient Normalization (MGN) according to the output vector, a gradient of the output vector, and the Lipschitz value to generate an output of the feedforward layer, as shown below:

$$y = K ( x ) \cdot \frac{f ( x )}{‖ ∇ f ( x ) ‖ + ϵ}$$

where ∇f(x) is the gradient of the output vector f(x), ∥∇f(x)∥ is the 2-norm of the Jacobian matrix relative to the input vector x, K(x) is the Lipschitz value modeled by the feedforward network K conditioned on input x, and e is a small positive value to avoid division by zero.

The embodiment of FIG. 4 modifies the learning component of the action network from an architectural perspective to reduce the oscillation frequency of actions. Two additional architecture-based embodiments include Spectral Normalization (SN) and Liu-Lipschitz. It should be noted that the embodiment of FIG. 4 can also be applied to the value network.

Spectral normalization is most commonly used to stabilize the training of Generative Adversarial Networks. It consists of a rescaling operation applied to the weights of a layer by its spectral norm σ(W). The normalized weights are given

$${W}_{S N} = δ \cdot \frac{W}{σ ( W )} .$$

The global version of spectral normalization applies to every layer, while the local version (Local SN) applies only to the output layer and typically performs better. In an embodiment, this method is implemented using Spectral Normalization in PyTorch, with δ=1.0, and no other hyperparameters are required.

The Liu-Lipschitz method was originally used to learn a smooth mapping for neural distance fields networks, such that interpolation and extrapolation of shapes are possible. This method constrains the Lipschitz upper bound of the network as a learnable parameters cᵢ per layer. The weights of each layer are normalized using cᵢ, and the output of the layer is calculated as follows:

$$\begin{matrix}y = σ ( \hat{{W}_{ι}} \cdot x + {b}_{i} ) \\ \hat{{W}_{ι}} = norm a lization ( {W}_{i} , softplus ( {c}_{i} ) )\end{matrix}$$

where Ŵₗ are the normalized weights, and σ(·) is an activation function. This method also includes a loss function element that minimizes the value of cᵢ and has the form:

$${ℒ}_{c} = λ {\prod }_{i}^{N} softplus ( {c}_{i} )$$

where λ is a tunable hyperparameter, and N is the number of layers in the network, with a single cᵢ per layer.

The two Lipschitz-based methods described above also introduce an additional term into the loss function, but this is intended to constrain the upper bound of the network's Lipschitz value, rather than directly optimizing state-action differences as is done in loss regularization methods.

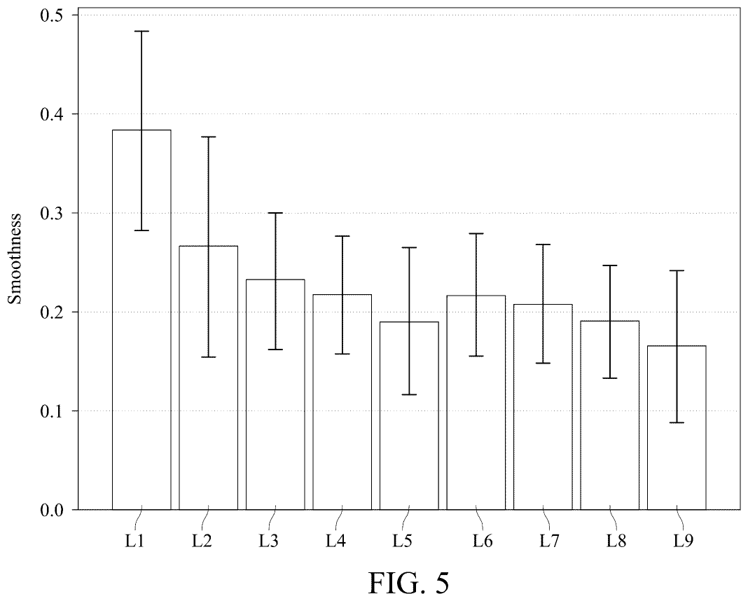

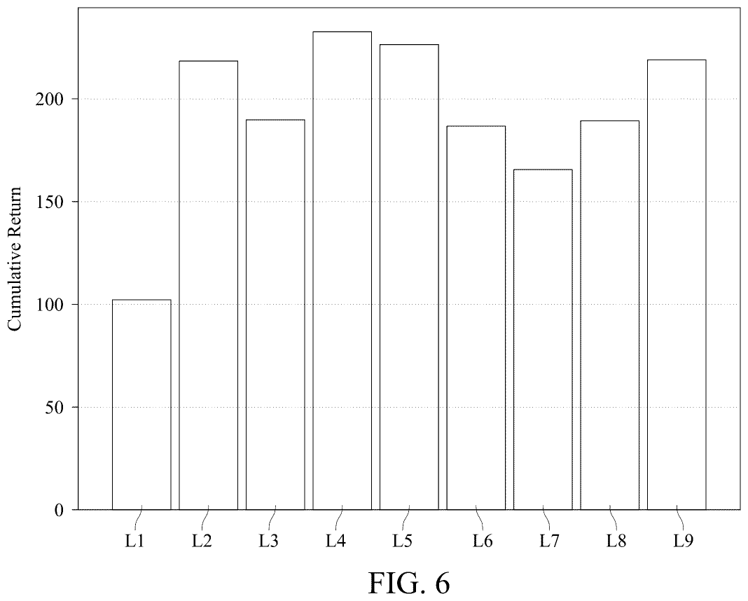

FIG. 5 and FIG. 6 present evaluation results of applying the present disclosure in a real-world robotic application, implemented using tools such as Isaac Gym, RL Games, and PyTorch. The robot's task is to track a velocity vector to walk and to follow a target direction vector. For this locomotion task, the present disclosure uses a quadruped robot in a real environment, with Domain Randomization (DR) employed to ensure successful transfer from simulation to the real world. By injecting noise into various elements during simulation, the policy can learn to operate effectively over a wider distribution of states.

In FIG. 5 and FIGS. 6, L1 to L9 correspond to the performance results (in terms of smoothness and cumulative return) of policies trained using different policy generation methods. L1 represents the baseline method without domain randomization. L2 is the baseline method. L3 and LA represent two embodiments of regularization-based loss functions, corresponding to FIG. 2 and FIG. 3, respectively. L5, L6, and L7 represent three network architecture-based embodiments. Specifically, L5 uses the local version of Spectral Normalization (Local SN), L6 uses the Liu-Lipschitz method, and L7 corresponds to FIG. 4. L8 is a hybrid version of L3 and L7, while L9 is a hybrid version of L4 and L7. Each method is trained from scratch with 9 different random seeds. Table 1 lists all the hyperparameters used during training.

TABLE 1
Hyperparameters used during training for each method.

| | | Motion | | |
|---|---|---|---|---|
| Method | Hyperparameter | Imitation | Velocity | Handstand |
| L3 | σ | 0.2 | 0.2 | 0.2 |
| | λ_{T} | 0.01 | 0.01 | 0.01 |
| | λ_{S} | 0.05 | 0.05 | 0.05 |
| L4 | σ | 1.0 | 1.0 | 1.0 |
| | λ | 0.01 | 0.01 | 0.01 |
| | λ̅ | 1.0 | 1.0 | 1.0 |
| | β | 0.1 | 0.1 | 0.1 |
| L7 | Weight λ | 0.001 | 0.001 | 0.0001 |
| | ϵ | 0.0001 | 0.0001 | 0.0001 |
| | Initial Lipschitz | 1.0 | 1.0 | 1.0 |
| | constant Kᵢₙᵢₜ | | | |
| | Hidden layers | [512, 256] | [512, 256] | [512, 256, 128] |
| | in f(x) | | | |
| | Activation | ELU | ELU | ELU |
| | in f(x) | | | |
| | Hidden layers | [32] | [32] | [32] |
| | in K(x) | | | |
| | Activation | tanh | tanh | tanh |
| | in in K(x) | | | |
| L6 | Weight λ | 1 × 10⁻⁶ | 1 × 10⁻⁵ | 1 × 10⁻⁶ |
| | Initial Lipschitz | 10.0 | 1.0 | 10.0 |
| | constant Kᵢₙᵢₜ | | | |

In FIG. 5 and FIG. 6, the evaluation metrics include Cumulative Return and Smoothness. Cumulative Return represents the total accumulated reward over all time steps in an episode, calculated as:

$$C = {\sum }_{t = 0}^{N} {R}_{T}$$

This metric provides a measure of the task performance of the policy. This metric is environment dependent, and is used primarily to analyze the trade-off between smoothness and performance.

Smoothness is computed from the frequency spectrum of a Fast Fourier Transform (FFT). The smoothness is a normalized weighted mean frequency and has the form:

$${S}_{m} = \frac{2}{n {f}_{s}} {\sum }_{i = 0}^{n} {M}_{i} {f}_{i}$$

where n is the number of frequency bands, f_{S} is the sampling frequency, and Mᵢ and fᵢ are the amplitude and frequency of band i, respectively. Higher values indicate the presence of high frequency components of large magnitude, and lower values indicate a smoother control signal. In the same manner as the cumulative return, a good smoothness value differs from environment to environment, but is independent of the policy control frequency.

As shown in FIGS. 5 and 6, each method achieves comparable performance in terms of cumulative return. Regarding smoothness, hybrid methods such as L8 and L9 consistently outperform the other methods (L1 to L7). Additionally, each of the methods from L3 to L9 shows smoother behavior than the baseline methods (L1 and L2).

In summary, the present disclosure provides a reinforcement learning-based agent policy generation method and a non-transitory computer-readable medium. Instead of relying on explicit reward penalty terms or environment adjustments (such as post-processing actions), the present disclosure adopts loss regularization and network architecture to encourage the policy to learn a smooth mapping, such that neighboring states in the input space result in neighboring actions in the output space. Experimental results demonstrate that the best-performing hybrid method improves smoothness by 26.8% over the baseline, with only a 2.8% degradation in the worst-case performance.

What is claimed is:

1. A reinforcement learning-based agent policy generation method comprising a plurality of steps performed by a computing device, with the plurality of steps comprising:
obtaining a first state, an action network and a value network of an agent, and a reward function of an environment in which the agent is located;
generating a first action for the agent to execute according to the action network and the first state, and generating a first value according to the value network and the first state;
obtaining a second state of the agent generated by the environment and a reward generated by the reward function;
storing the first state, the first action, the first value, the second state, and the reward into a buffer; and
training the value network and the action network according to the buffer;
wherein a loss function of the action network includes a policy gradient loss and a regularization loss, the regularization loss comprises a first distance and a second distance, the first distance is associated with the first action, and the second distance is associated with the first action or the first value.

2. The reinforcement learning-based agent policy generation method of claim 1, wherein the plurality of steps further comprises:
generating a second action according to the action network and the second state;
selecting a reference state from a normal distribution of the first state;
generating a reference action according to the action network and the reference state;
calculating the first distance between the first action and the second action;
calculating the second distance between the first action and the reference action; and
calculating a weighted sum of the first distance and the second distance as the regularization loss.

3. The reinforcement learning-based agent policy generation method of claim 1, wherein the plurality of steps further comprises:
calculating an interaction result between a random variable and a difference, wherein the difference is between the second state and the first state;
generating a reference state according to the first state and the interaction result;
generating a reference value according to the value network and the reference state;
generating a reference action according to the action network and the reference state;
calculating the first distance between the first action and the reference action;
calculating the second distance between the first value and the reference value; and
calculating a weighted sum of the first distance and the second distance as the regularization loss.

4. The reinforcement learning-based agent policy generation method of claim 1, wherein a feedforward layer of the action network comprises:
generating an output vector according to an input vector by a first multilayer perceptron;
generating a Lipschitz value according to the input vector by a second multilayer perceptron connected to an activation function; and
performing a multi-dimensional gradient normalization according to the output vector, a gradient of the output vector, and the Lipschitz value to generate an output of the feedforward layer.

5. A non-transitory computer-readable medium storing a plurality of instructions, wherein the plurality of instructions is configured to be performed by a computing device and cause a plurality of operations, and the plurality of operations comprises:
obtaining a first state, an action network and a value network of an agent, and a reward function of an environment in which the agent is located;
generating a first action for the agent to execute according to the action network and the first state, and generating a first value according to the value network and the first state;
obtaining a second state of the agent generated by the environment and a reward generated by the reward function;
storing the first state, the first action, the first value, the second state, and the reward into a buffer; and
training the value network and the action network according to the buffer;
wherein a loss function of the action network includes a policy gradient loss and a regularization loss, the regularization loss comprises a first distance and a second distance, the first distance is associated with the first action, and the second distance is associated with the first action or the first value.

6. The non-transitory computer-readable medium of claim 5, wherein the plurality of operations further comprises:
generating a second action according to the action network and the second state;
selecting a reference state from a normal distribution of the first state;
generating a reference action according to the action network and the reference state;
calculating the first distance between the first action and the second action;
calculating the second distance between the first action and the reference action; and
calculating a weighted sum of the first distance and the second distance as the regularization loss.

7. The non-transitory computer-readable medium of claim 5, wherein the plurality of operations further comprises:
calculating an interaction result between a random variable and a difference, wherein the difference is between the second state and the first state;
generating a reference state according to the first state and the interaction result;
generating a reference value according to the value network and the reference state;
generating a reference action according to the action network and the reference state;
calculating the first distance between the first action and the reference action;
calculating the second distance between the first value and the reference value; and
calculating a weighted sum of the first distance and the second distance as the regularization loss.

8. The non-transitory computer-readable medium of claim 5, wherein a feedforward layer of the action network comprises:
generating an output vector according to an input vector by a first multilayer perceptron;
generating a Lipschitz value according to the input vector by a second multilayer perceptron connected to an activation function; and
performing a multi-dimensional gradient normalization according to the output vector, a gradient of the output vector, and the Lipschitz value to generate an output of the feedforward layer.
